(19) United States
(12) Patent Application Publication
(10) Pub. No.: US 2026/0307977 A1
(43) Pub. Date: Oct. 8, 2026

(54) Robotic Gas Pump for Autonomous Vehicle Refueling

(71) Applicant: John Henderson, Compton, CA (US)

(72) Inventor: John Henderson, Compton, CA (US)

(21) Appl. No.: 19/284,775

(22) Filed: Jul. 30, 2025

Related U.S. Application Data
(60) Provisional application No. 63/785,055, filed on Apr. 8, 2025.

(51) Int. Cl. B67D 7/04

(52) U.S. Cl. CPC B67D 7/0401; B67D 2007/0417; B67D 2007/0442

(57) ABSTRACT

An automated or autonomous gas pump system for refueling vehicles without requiring users to exit their vehicles is disclosed. The system includes a fuel dispensing unit having a housing, a user interface assembly with a touchscreen display, manual keypad, and payment module for selecting fuel type, fuel quantity/amount, and authorizing transactions. A robotic arm housed within the unit is configured with at least four degrees of freedom to autonomously align a fuel nozzle with a vehicle's fuel inlet. The robotic arm includes integrated sensors such as proximity, torque, and pressure sensors for precise engagement and safety control. A flexible hose connects the fuel nozzle to an internal fuel delivery system fed by underground or above-ground storage tanks. The system features an illumination unit for visibility and status indication, a unique identifier for pump tracking, and a service door for maintenance.

### CROSS REFERENCE TO RELATED APPLICATION

The present application claims priority to, and the benefit of, U.S. Provisional Application No. 63/785,055 which was filed on Apr. 8, 2025 and is incorporated herein by reference in its entirety.

### FIELD OF THE INVENTION

The present invention generally relates to fuel dispensing systems for vehicles. More specifically, the present invention relates to an automated, contactless gas pump system configured to improve convenience, safety, and efficiency in vehicle refueling. The invention comprises a robotic fueling unit, a user interface assembly for fuel selection and payment authorization, and a multi-jointed robotic arm designed to autonomously align with and engage a vehicle's fuel tank inlet. The user interface includes a touchscreen display, a keypad for manual input selection, and a payment module capable of processing card or mobile transactions. The robotic arm, which is stored within the housing, extends outward upon activation. A fuel nozzle attached to the terminal end of the arm is fluidly connected to a high-pressure hose for dispensing fuel. Accordingly, the present disclosure makes specific reference thereto. Nonetheless, it is to be appreciated that aspects of the present invention are also equally applicable to other like applications, devices, and methods of manufacture.

### BACKGROUND

By way of background, pumping fuel into a vehicle is a routine and mandatory task but many vehicle owners find pumping fuel inconvenient and time-consuming. The conventional process of pumping fuel requires the driver to stop, exit the vehicle, operate a manual fuel nozzle, and endure unfavorable weather conditions or unsanitary contact with shared surfaces. The procedure becomes particularly burdensome for individuals with physical limitations, during inclement weather, or in high traffic fueling stations.

Vehicular technology has improved immensely; however, the gas pumping process has remained largely unchanged and manual in operation. Individuals desire a fully automated or autonomous and intelligent system capable of refueling a vehicle without requiring the driver to exit the vehicle.

Therefore, there exists a long-felt need in the art for a fuel dispensing solution that eliminates the inconvenience and physical effort associated with traditional gas pumping methods. There is a long-felt need for a system that enables drivers to refuel their vehicles without leaving the driver's seat. Furthermore, there is a need for a gas pump that minimizes the risk of user error, enhances operational efficiency at fueling stations, and reduces contact with high-touch public surfaces. Additionally, there is a need for a system that provides precise, sensor-driven fuel delivery while maintaining user safety and operational integrity. Finally, there is a long-felt need for a pump station that prevents individuals from having to get out of their car to pump gas and saves considerable time and effort for any vehicle owner.

The subject matter disclosed and claimed herein, in one embodiment, comprises an automated or autonomous gas dispensing system including durable, anchored housing, a user interface assembly, a robotic fueling arm, and an integrated sensor and safety module. The user interface assembly comprises a touchscreen display, a keypad, and a payment module configured for fuel selection and transaction authorization. The robotic arm, housed within the pump unit, is extendable and retractable and includes multiple degrees of freedom to locate and align with a vehicle's fuel tank inlet. A fuel nozzle attached to the terminal end of the arm is fluidly connected to a flexible, high-pressure hose that delivers fuel from an underground or above-ground reservoir. The system includes a proximity sensor for locating the inlet, a torque sensor to detect insertion resistance, and a pressure sensor for monitoring fuel flow. The system dispenses fuel only upon secure connection between the nozzle and the vehicle.

In this manner, the automatic or autonomous gas pump system of the present invention overcomes the limitations of conventional manual fuel dispensing solutions by providing a fully autonomous, sensor-integrated system that enables contactless vehicle refueling. The system enables users to select fuel type, authorize payment, and receive fuel without exiting the vehicle, thereby enhancing convenience, accessibility, and hygiene. The robotic arm delivers precise, leak-proof alignment and fuel transfer. Additionally, the system incorporates user guidance indicators, status lighting, and a service access door for routine maintenance and manual override. The system is suitable for use in public gas stations, commercial fleets, and autonomous fueling depots, offering a scalable and efficient solution to a longstanding need in the fuel dispensing industry.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automatic or autonomous gas pump system configured for refueling a vehicle without requiring a user to exit the vehicle. The system includes a housing structure that is securely anchored to a fixed foundation and a user interface assembly mounted on the housing. The interface comprises a display screen for selecting fuel types, a keypad for inputting the desired fuel amount, and a payment module for receiving user credentials and authorizing payment. A robotic arm is disposed within the housing and is capable of extending and retracting relative to the housing. The robotic arm features at least four degrees of freedom, enabling spatial movement to position a fuel nozzle, which is operatively attached to the arm's terminal end. The fuel nozzle is fluidly connected via a flexible hose to an internal fuel delivery line for transferring fuel from a storage tank to the vehicle's fuel tank inlet.

In one embodiment, the robotic arm is equipped with a proximity sensor for detecting the location of a vehicle's fuel tank inlet, and a torque sensor near the fuel nozzle to detect insertion resistance or obstructions. A pressure sensor is integrated to monitor fuel dispensing pressure and assist in terminating the fueling process upon completion.

In another embodiment, the automatic or autonomous gas pump system includes a safety control mechanism that prevents the flow of fuel until a secure, leak-proof connection is established between the nozzle and the fuel tank inlet of the vehicle. A sensor array, including at least a torque sensor and a proximity sensor, continuously monitors the interaction between the nozzle and the vehicle. The sensors detect misalignment, physical obstruction, or abnormal resistance.

In one embodiment, a method of refueling a vehicle without requiring a user to exit the vehicle using an automated or autonomous gas pump is described. The method includes the steps of initially aligning the vehicle alongside the automated or autonomous gas pump such that the vehicle's fuel tank inlet is aligned with the pump station. Then, the pump receives a request for a fuel grade such as regular, premium, diesel, or more and a request for a desired fuel amount. Then, payment is received from the user such as by inserting a payment card or scanning a mobile payment system. Upon successful authentication of the payment, the pump system activates a robotic arm, and diagnostic checks are performed on the robotic arm. Further, for recording and inspection, the vehicle profile may be retrieved (via license plate recognition, user database, or model detection). Thereafter, the robotic arm exits the housing and extends toward the fuel tank to match the detected alignment of the fuel inlet and engages the fuel door. Then, the robotic arm inserts the fuel nozzle into the vehicle's fuel inlet in a secure, leak-proof connection before fuel delivery begins.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of automatic or autonomous gas pump system of the present invention in accordance with the disclosed structure;

FIG. 2 illustrates a block diagram showing the electronic components included in the robotic arm of the pump system in accordance with the disclosed structure;

FIG. 3 illustrates a flow chart depicting steps of using the automated or autonomous gas dispensing system in accordance with one embodiment of the present invention;

FIG. 4 illustrates a perspective view showing the flow of fuel from an internal reservoir to the nozzle in accordance with the disclosed structure; and

FIG. 5 illustrates a perspective view of an automated or autonomous gas dispensing system of the present invention in operational configuration with a vehicle in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a fuel dispensing solution that eliminates the inconvenience and physical effort associated with traditional gas pumping methods. There is a long-felt need for a system that enables drivers to refuel their vehicles without leaving the driver's seat. Furthermore, there is a need for a gas pump that minimizes the risk of user error, enhances operational efficiency at fueling stations, and reduces contact with high-touch public surfaces. Additionally, there is a need for a system that provides precise, sensor-driven fuel delivery while maintaining user safety and operational integrity. Finally, there is a long-felt need for a pump station that prevents individuals from having to get out of their car to pump gas and saves considerable time and effort for any vehicle owner.

The present invention, in one exemplary embodiment, is an automatic or autonomous gas pump system configured for refueling a vehicle without requiring a user to exit the vehicle. The system includes a housing structure that is securely anchored to a fixed foundation and a user interface assembly mounted on the housing. The interface comprises a display screen for selecting fuel types, a keypad for inputting the desired fuel amount, and a payment module for receiving user credentials and authorizing payment. A robotic arm is disposed within the housing and is capable of extending and retracting relative to the housing. The robotic arm features at least four degrees of freedom, enabling spatial movement to position a fuel nozzle, which is operatively attached to the arm's terminal end.

Reference will now be made in detail to the present preferred embodiments of the invention, examples of which are illustrated in the accompanying drawings. Wherever possible, the same reference numerals are used in the drawings and the description to refer to the same or like parts.

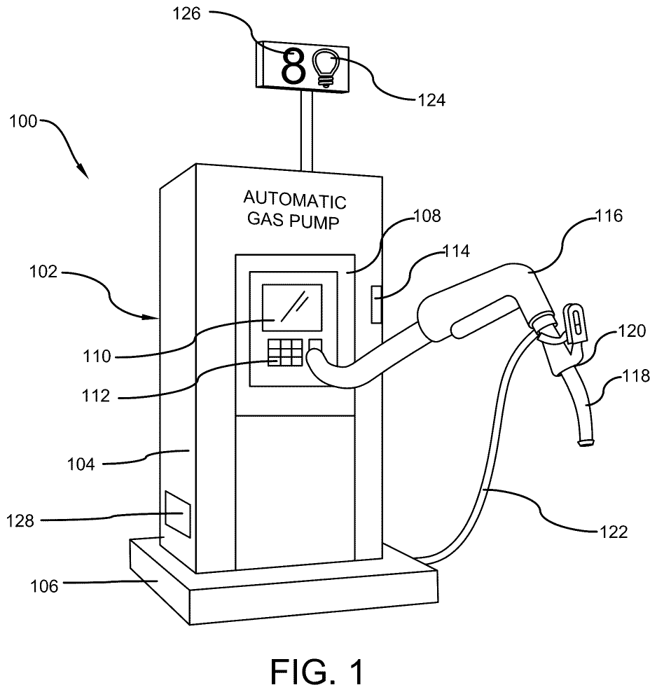

Referring initially to the drawings, FIG. 1 illustrates a perspective view of automatic or autonomous gas pump system of the present invention in accordance with the disclosed structure. The automatic or autonomous gas pump system 100 of the present invention is designed as an intelligent, automated fueling solution and configured for refueling a vehicle without requiring user intervention outside the vehicle. The automatic or autonomous gas pump system 100 includes a fuel dispensing unit 102 which has a durable housing 104. The housing 104 is anchored using a fixed foundation 106 such as a cement foundation.

A user interface assembly 108 is mounted on the housing 104 and includes a display screen 110 for displaying various types of fuels available for selection as described later in the disclosure. The display screen 110 is preferably touchscreen and additionally, a keypad 112 is included in the user interface assembly 108 for manual input selection of a fuel type. The user interface assembly 108 is also used for inputting the cost of the fuel (i.e., the dollar amount of fuel) to be dispensed from the fuel dispensing unit 102. A payment module 114 is operable to receive user credentials and payment information such as a card to facilitate and authorize fuel purchases using the fuel dispensing unit 102.

A robotic arm 116 is disposed within the housing 104 and is selectively extendable and retractable relative to the housing 104. The robotic arm 116 is designed to autonomously locate, align with, and engage the fuel inlet of a vehicle. The robotic arm 116 can perform dexterous manipulation tasks in an outdoor, semi-structured environment, and is capable of withstanding weather, thermal, and mechanical stress common to automotive fueling environments. The robotic arm 116 has at least three Degrees Of Freedoms (DOF) for spatial movement including yaw, shoulder pitch, and elbow pitch.

A fuel nozzle 118 is operatively attached to a terminal end 120 of the robotic arm 116. The fuel nozzle 118 is configured to engage with a vehicle's fuel tank inlet for transferring the fuel. A flexible hose 122 is fluidly connected to the nozzle 118 to deliver a selected volume or selected dollar amount of fuel via the fuel nozzle 118.

An illumination unit 124 is included in the automatic or autonomous gas pump system 100 to enhance visibility during nighttime or low-light conditions. The illumination unit 124 also functions as a status signal as it illuminates in different colors such as green for ready and red for error (i.e., not ready). The illumination unit 124 reduces the risk of misalignment or accidents during nighttime auto-fueling and complies with safety and accessibility standards often required at commercial stations. A unique identifier 126 is included in the pump system 100 to help drivers know the pump they are using. The unique identifier 126 assists in monitoring and maintenance, enabling staff or remote systems to track service needs, errors, or usage per unit.

A service door 128 in the automatic or autonomous gas pump 100 enables authorized personnel to perform servicing of the pump. The service door 128 provides access to internal fuel lines, connectors, and more to facilitate lubrication, wear checks, or hardware recalibration. The service door 128 can also be used for shutting down the pump system or retracting the robotic arm manually.

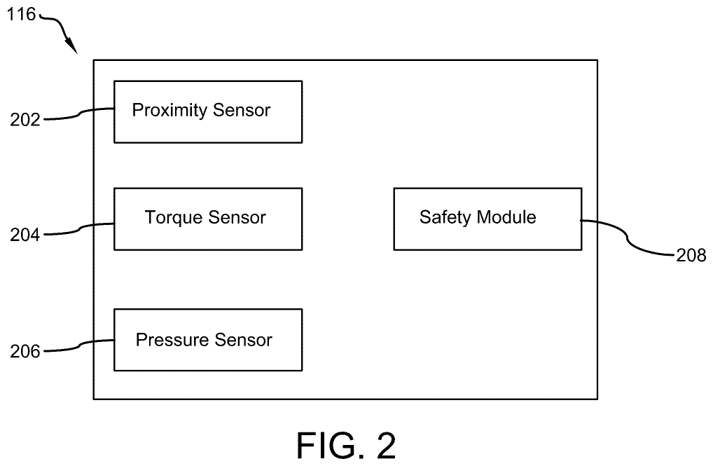

FIG. 2 illustrates a block diagram showing the electronic components included in the robotic arm of the pump system in accordance with the disclosed structure. As illustrated, robotic arm 116 includes a proximity sensor 202 to detect a fuel inlet of a vehicle. The proximity sensor 202 can be an active sensor or a passive sensor as per the manufacturing requirements of the pump system 100.

A torque sensor 204 is located near the end effector of the robotic arm 116 and detects resistance or obstruction for a precise insertion into the fuel inlet of the vehicle. A pressure sensor 206 monitors the dispensing fuel pressure from the nozzle 118 and helps the robotic arm 116 to move away from the fuel inlet when the fuel is dispensed.

A safety module 208 in the form of an actuator is included in the robotic arm 116 and prevents fuel flow until the fuel nozzle 118 is securely engaged with the fuel tank inlet of a vehicle. The safety module 208 also automatically halts fuel dispensing in response to error conditions, misalignment, or emergency signals within the pump system 100.

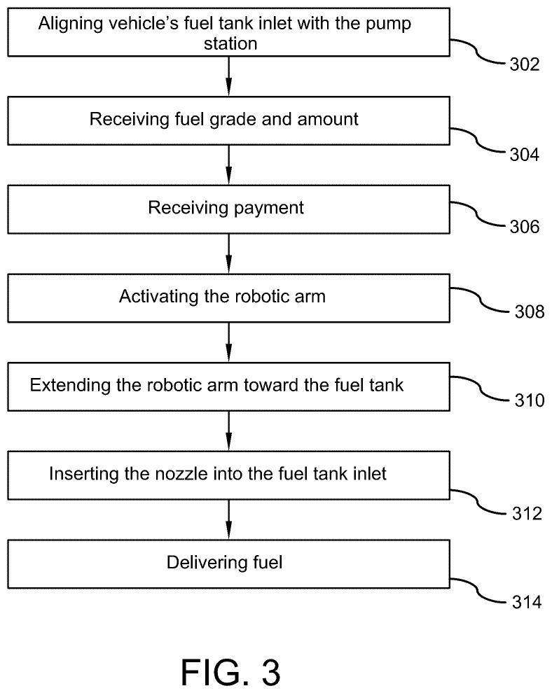

FIG. 3 illustrates a flow chart depicting steps of using the automated or autonomous gas dispensing system in accordance with one embodiment of the present invention. Initially, a user operates a vehicle and pulls up alongside the automated or autonomous gas pump 100 such that the vehicle's fuel tank inlet is aligned with the pump station (Step 302). Optional indicators such as visual cues, or vehicle detection sensors may be included to confirm correct alignment.

Then, the user interacts with the user interface assembly 108 for selecting a fuel grade such as regular, premium, diesel, or more and a desired fuel amount (Step 304). A payment is made using the payment module such as by inserting a payment card or scanning a mobile payment system (Step 306).

Upon successful authentication of the payment, the pump system 100 activates the robotic arm 116 (Step 308). Diagnostic checks can be performed on the robotic arm, sensors, and fuel nozzle. Further, for recording and inspection, the vehicle profile may be retrieved (via license plate recognition, user database, or model detection).

Thereafter, the robotic arm 116 exits the housing and extends toward the fuel tank to match the detected alignment of the fuel inlet and engages the fuel door, optionally opening it automatically (Step 310). Then, the robotic arm 116 inserts the fuel nozzle into the vehicle's fuel inlet in a secure, leak-proof connection before fuel delivery begins (Step 312).

Thereafter, fuel is delivered from the internal reservoir through the hose and nozzle into the vehicle's tank (Step 314). Flow rate, volume, and dollar amount are monitored in real time using internal sensors as described in FIG. 2. The system automatically stops upon reaching the preselected quantity, full tank status or preselected dollar amount. The robotic arm can retract the nozzle from the vehicle and returns to the resting or stowed position inside the pump housing.

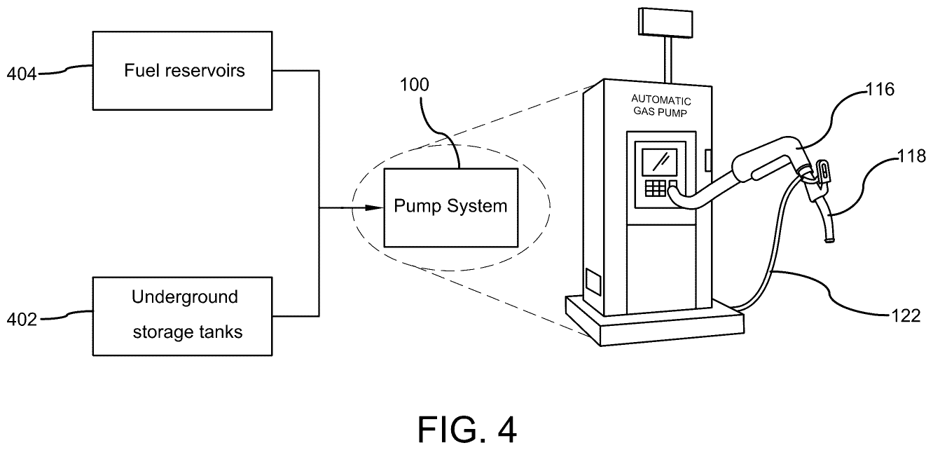

FIG. 4 illustrates a perspective view showing the flow of fuel from an internal reservoir to the nozzle in accordance with the disclosed structure. The pump system 100 is connected to underground storage tanks (USTs) 402 and/or secure above-ground fuel reservoirs 404. Each tank typically holds a specific grade of fuel for dispensing through the pump station 100. Fuel flows through a fuel delivery line 406 to the robotic fuel pump system 100 and may be filtered and controlled for regulated pressure.

Then, when the robotic arm 116 is activated, fuel is routed through the flexible, retractable hose 122 attached to the robotic arm 116. The hose is configured for high-pressure tolerance and dynamic movement and can be made of reinforced synthetic rubber or thermoplastic. The safety interlock mechanism of the robotic arm 116 provides a sealed connection between the fuel tank inlet of a vehicle and nozzle of the pump system.

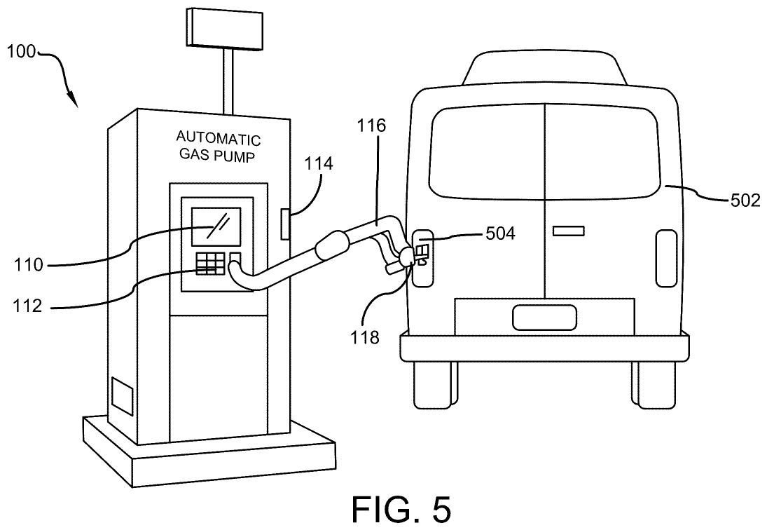

FIG. 5 illustrates a perspective view of an automated or autonomous gas dispensing system of the present invention in operational configuration with a vehicle in accordance with one embodiment of the present invention. The automatic or autonomous gas pump unit 100 includes a user interface panel 110 configured with a payment input 114 and display module 112, through which a user may initiate a fuel transaction, select fuel grade, and authorize payment as described in FIG. 4. The robotic arm assembly 116 is configured to extend toward the vehicle 502. The robotic arm is equipped with the fuel nozzle 118, which is maneuvered automatically or autonomously to engage the fuel inlet 504 of the vehicle 502. In this embodiment, the robotic arm 116 is shown actively engaged in the process of delivering fuel to the vehicle 502 via the nozzle 118.

The robotic arm 116 may operate under control of an internal processor (not shown) which receives commands based on user input at the interface 110 and sensor data determining the position and orientation of the vehicle 502. Once alignment with the fuel inlet 504 is verified, the nozzle 118 is inserted, and the fuel is dispensed.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automatic or autonomous gas pump system”, “robotic fuel dispensing system”, “robotic fuel pump system”, “automated or autonomous gas dispensing system”, and “system” are interchangeable and refer to the robotic fuel pump system 100 of the present invention.

Notwithstanding the foregoing, the robotic fuel pump system 100 of the present invention can be of any suitable configuration as is known in the art without affecting the overall concept of the invention, provided that it accomplishes the above stated objectives. One of ordinary skill in the art will appreciate that the robotic fuel pump system 100 as shown in the FIGS. are for illustrative purposes only, and that many other configurations of the robotic fuel pump system 100 are well within the scope of the present disclosure. Although the dimensions of the robotic fuel pump system 100 are important design parameters for user convenience, the robotic fuel pump system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An autonomous gas pump system comprising:
a fuel dispensing system having a fuel dispensing unit and a user interface for autonomous refueling of a vehicle;
a payment module;
a robotic arm; and
a flexible hose;
wherein said fuel dispensing unit having a housing and a foundation;
wherein said user interface mounted to said housing;
wherein said user interface having a keypad and a display screen for displaying types of fuel and costs of fuel available for selection;
wherein said display screen having a touchscreen;
wherein said user interface providing input selections selected from the group consisting of a fuel type, a fuel amount, and a fuel dollar amount;
wherein said payment module operable to receive user credentials and payment information to authorize fuel purchases using said fuel dispensing system;
wherein said robotic arm connected to said housing;
wherein said robotic arm selectively extendable and retractable relative to said housing; and
further wherein said robotic arm autonomously locates, aligns with, and engages a fuel inlet of the vehicle.

2. The autonomous gas pump system of claim 1, wherein said robotic arm having at least three Degrees Of Freedoms (DOF) for spatial movement selected from the group consisting of yaw movement, shoulder pitch movement, and elbow pitch movement.

3. The autonomous gas pump system of claim 2, wherein said robotic arm having a fuel nozzle operatively attached to a terminal end of said robotic arm.

4. The autonomous gas pump system of claim 3, wherein said fuel nozzle engageable with said fuel inlet of the vehicle for transferring the fuel.

5. The autonomous gas pump system of claim 4, wherein said flexible hose fluidly connected to said fuel nozzle to deliver at least one of a selected said fuel amount and a selected said fuel dollar amount of the fuel through said fuel nozzle.

6. The autonomous gas pump system of claim 5 further comprising an illumination unit for signaling a status color including a green color for ready and a red color for not ready.

7. The autonomous gas pump system of claim 5, wherein said robotic arm comprises a proximity sensor for detecting said fuel inlet of the vehicle.

8. The autonomous gas pump system of claim 7, wherein said fuel nozzle having a torque sensor for detecting resistance to guide insertion of said fuel nozzle into said fuel inlet of the vehicle.

9. The autonomous gas pump system of claim 8, wherein said fuel nozzle comprises a pressure sensor for monitoring a dispensing fuel pressure from said fuel nozzle.

10. The autonomous gas pump system of claim 9 further comprising a safety module having an actuator in said robotic arm for preventing fuel flow until said fuel nozzle is engaged with said fuel inlet of the vehicle.

11. The autonomous gas pump system of claim 10, wherein said safety module halts the fuel dispensing in response to a condition selected from the group consisting of an error condition, a misalignment condition, and an emergency signal condition.

12. An autonomous gas pump system comprising:
a fuel dispensing system having a fuel dispensing unit and a user interface for autonomous refueling of a vehicle;
a payment module;
a robotic arm; and
a flexible hose;
wherein said fuel dispensing unit having a housing and a foundation;
wherein said user interface mounted to said housing;
wherein said user interface having a keypad and a display screen for displaying types of fuel and costs of fuel available for selection;
wherein said display screen having a touchscreen;
wherein said user interface providing input selections selected from the group consisting of a fuel type, a fuel amount, and a fuel dollar amount;
wherein said payment module operable to receive user credentials and payment information to authorize fuel purchases using said fuel dispensing system;
wherein said robotic arm connected to said housing;
wherein said robotic arm selectively extendable and retractable relative to said housing;
wherein said robotic arm autonomously locates, aligns with, and engages a fuel inlet of the vehicle;
wherein said robotic arm having a proximity sensor for detecting said fuel inlet of the vehicle; and
further wherein said fuel nozzle having a torque sensor for detecting resistance to guide insertion of said fuel nozzle into said fuel inlet of the vehicle.

13. The autonomous gas pump system of claim 12, wherein said robotic arm having at least three Degrees Of Freedoms (DOF) for spatial movement selected from the group consisting of yaw movement, shoulder pitch movement, and elbow pitch movement.

14. The autonomous gas pump system of claim 13, wherein said robotic arm having a fuel nozzle operatively attached to a terminal end of said robotic arm.

15. The autonomous gas pump system of claim 14, wherein said fuel nozzle engageable with said fuel inlet of the vehicle for transferring the fuel.

16. The autonomous gas pump system of claim 15, wherein said flexible hose fluidly connected to said fuel nozzle to deliver at least one of a selected said fuel amount and a selected said fuel dollar amount of the fuel through said fuel nozzle.

17. A method for autonomous fueling of a vehicle at a gas pump, the method comprising the steps of:
providing a fuel dispensing system having a fuel dispensing unit and a user interface for autonomous refueling of a vehicle, a payment module, a robotic arm, and a flexible hose, wherein said fuel dispensing unit having a housing and a foundation, wherein said user interface mounted to said housing;
connecting said robotic arm to said housing;
displaying types of fuel and costs of fuel at said user interface for selection, wherein said user interface having a keypad and a display screen, wherein said display screen having a touchscreen, wherein said user interface providing input selections selected from the group consisting of a fuel type, a fuel amount, and a fuel dollar amount;
receiving user credentials and payment information at said payment module to authorize fuel purchases using said fuel dispensing system;
selectively extending and retracting said robotic arm relative to said housing, wherein said robotic arm autonomously locates, aligns with, and engages a fuel inlet of the vehicle;
detecting said fuel inlet of the vehicle with a proximity sensor of said robotic arm;
detecting resistance with a torque sensor of said fuel nozzle to guide insertion of said fuel nozzle into said fuel inlet of the vehicle; and
engaging said fuel nozzle with said fuel inlet of the vehicle for transferring the fuel.

18. The method for autonomous fueling of a vehicle at a gas pump of claim 17, wherein said robotic arm having at least three Degrees Of Freedoms (DOF) for spatial movement selected from the group consisting of yaw movement, shoulder pitch movement, and elbow pitch movement.

19. The method for autonomous fueling of a vehicle at a gas pump of claim 18, wherein said robotic arm having a fuel nozzle operatively attached to a terminal end of said robotic arm.

20. The method for autonomous fueling of a vehicle at a gas pump of claim 19, wherein said flexible hose fluidly connected to said fuel nozzle to deliver at least one of a selected said fuel amount and a selected said fuel dollar amount of the fuel through said fuel nozzle.
